(19) United States
(12) Patent Application Publication
(10) Pub. No.: US 2026/0318836 A1
(43) Pub. Date: Oct. 15, 2026

(54) DEVICE AND METHOD FOR RAMAN SPECTROSCOPY

(71) Applicant: FERDINAND-BRAUN-INSTITUT GGMBH LEIBNIZ-INSTITUT FUER HOECHSTFREQUENZTECHNIK, Berlin (DE)

(72) Inventors: Bernd SUMPF, Wildau (DE); Martin MAIWALD, Berlin (DE)

(73) Assignee: FERDINAND-BRAUN-INSTITUT GGMBH LEIBNIZ-INSTITUT FUER HOECHSTFREQUENZTECHNIK, Berlin (DE)

(21) Appl. No.: 19/113,787

(22) PCT Filed: Jul. 12, 2023
(86) PCT No.: PCT/EP2023/069354

§ 371 Date: Mar. 20, 2025

(30) Foreign Application Priority Data
Sep. 22, 2022 (DE) 10 2022 124 375.3

(51) Int. Cl. G01N 21/65

(52) U.S. Cl. CPC G01N 21/65; G01N 2201/06113

(57) ABSTRACT

Devices and methods for Raman spectroscopy are provided and comprise a spectrally tunable laser source modulated using a modulation signal, a spectral filter element, and a detector for measuring the intensity of an excitation radiation of the laser source, wherein the excitation radiation is scattered by a sample and filtered by the spectral filter element. The devices and methods further comprise means for tuning the laser source, and a lock-in device designed to filter a Raman signal of the sample out of the measurement signal when using the modulation signal as a reference signal, wherein the Raman signal occurs within the spectral filter width of the spectral filter and is modulated by means of the modulation signal.

### APPARATUS AND METHOD FOR RAMAN SPECTROSCOPY

This application is a 371 of International Patent Application No. PCT/EP2023/061506, filed Jul. 12, 2023, which claims foreign priority benefit under 35 U.S.C. § 119 of the German Patent Application No. DE 10 2022 124 375.3, filed Sep. 22, 2022, these disclosures of which are incorporated herein by reference.

The present invention relates to an apparatus and a method for Raman spectroscopy, in particular an apparatus and a method for high-resolution Raman spectroscopy with a spectrally tunable monochromatic laser source that is spectrally modulated by a modulation signal for exciting a sample and a lock-in apparatus for improving a signal-to-noise ratio of a Raman signal of the sample in an associated measurement signal and occurring within the spectral filter width of a narrow-band spectral filter element.

### BACKGROUND OF THE DISCLOSURE

Raman spectroscopy is increasingly being put to use in industrial process and environmental measurement technology due to its suitability for in-situ and online analysis. One disadvantage, however, is that in practice some samples, as a result of fluorescence and/or due to their scattering properties, yield spectra whose quality is impaired by a high background, in particular when working with measurement times of less than 1 s, without elaborate sample preparation and/or with small-scale apparatus.

In Raman spectroscopy, a sample to be investigated is typically irradiated with excitation radiation of a fixed, but spectrally largely freely selectable excitation wavelength. The excitation radiation inelastically scattered by the sample is then collected from the sample location using a suitable spectroscopy setup and spectrally analyzed. Depending on the sample's specific material characteristics, individual Raman lines appear in the recorded spectrum that have a precisely defined spectral spacing from the excitation wavelength of the excitation radiation (this is conventionally denoted wavenumber spacing) that is characteristic of the sample under investigation.

In addition to a high spectral resolution, the spectrometer used to record a Raman spectrum must be sufficiently highly sensitive to light in order to record scattering spectra. Typically, such a spectrometer has a high-resolution grating as a wavelength-selective element and an appropriately low-noise multichannel detector, for example an electronically or liquid nitrogen-cooled CCD camera, for detection. Such spectrometers are often costly and are not suitable for constructing particularly small, compact and robust spectroscopy setups.

Another disadvantage of conventional spectroscopy setups is their relatively low sensitivity, as the narrow-band filtering by the wavelength-selective element means that only a low intensity can be acquired in each wavelength range it acquires and thus the measured Raman signals have a low signal-to-noise ratio (SNR). Although the SNR can be increased by increasing the intensity of the excitation radiation or extending the respective integration time, such measures are subject to tight limits depending on the use case. Excessive excitation power can on the one hand affect or even destroy the sample and on the other particularly short measurement times are required for monitoring chemical processes or detecting hazardous substances.

EP 3309538 λ₁ and EP 3660474 λ₁ also disclose spectroscopy setups with a tunable monochromatic excitation source in which a specific Raman signal from a sample is selectively detected via a spectrally narrow-band filter element. The SNR can here be enhanced by specifically exciting the sample with excitation radiation from a narrow-band wavelength range that is particularly suitable for the sample, without the spectroscopy setup having to be specially adapted. The single-channel detectors used here for signal acquisition enable rapid signal acquisition, wherein detection sensitivity can be significantly increased compared to conventional setups. However, for more reliable, more accurate and faster Raman spectroscopy of samples, even under non-optimal excitation conditions, the SNR of the acquired Raman signals must be further increased for a wider range of applications.

### SUMMARY OF THE DISCLOSURE

It is therefore an object of present invention to provide an apparatus and a method for high-resolution Raman spectroscopy that enables an increase in SNR relative to the prior art and thus shortens the required integration time while simultaneously increasing the sensitivity of the spectroscopy setup.

These objects are achieved according to the invention by the features of claims 1, 9 and 10. Advantageous configurations of the invention are recited in the dependent claims. The features individually listed in the claims can be combined with one another in a technically meaningful way and can be supplemented by explanatory facts from the description and/or details from the figures, wherein further variant embodiments of the invention are indicated. A first aspect of the invention relates to an apparatus for Raman spectroscopy comprising a spectrally tunable laser source set up to emit a monochromatic first form of excitation radiation of a first wavelength λ₁ from a first wavelength range Δλ₁ for exciting a sample; a spectral filter element at a filter wavelength v_{Filter} and with a spectral filter width Δv_{Filter}, wherein the first wavelength range Δλ₁ and the spectral filter width Δv_{Filter} relate to disjoint spectral ranges; a detector for measuring the intensity of the excitation radiation scattered by the sample and filtered by the spectral filter element as a measurement signal; a means for tuning the laser source, wherein, for tuning the first wavelength λ₁ of the laser source, modulation is performed with a first modulation signal of frequency f_{mod1} (within the associated first wavelength range Δλ₁); and a lock-in apparatus set up to filter out from the measurement signal, using the first modulation signal as a reference signal, a Raman signal of the sample occurring within the spectral filter width Δ_{vFilter} of the spectral filter element and modulated with the first modulation signal. Using the first modulation signal as a reference signal, the lock-in apparatus can thus enhance a signal-to-noise ratio in the measurement signal of a Raman signal of the sample occurring within the spectral filter width Δv_{Filter} Of the spectral filter element and modulated with the first modulation signal.

In Raman spectroscopy, the occurrence of at least one specific Raman line is spectroscopically investigated on excitation of a sample with an excitation radiation. In particular, this is taken for the purposes of the present invention to mean a spectroscopic investigation of a sample at at least one preselected Raman line of the sample. It is, however, also possible merely to investigate the presence of the corresponding Raman line in an unknown sample.

Monochromatic excitation radiation is taken to mean radiation of a small spectral width at a determined center wavelength as the excitation wavelength. Such excitation radiation can typically be emitted by diode lasers or laser diodes in single-mode operation. The spectral width should be selected to match the spectral resolution of the measuring system and the spectral width of the Raman line to be investigated. Particular preference is here given in particular to center wavelengths of around 785 nm with a spectral half-value width (“full width at half maximum”, FWHM) of less than 1 nm.

The laser source is spectrally tunable over a first wavelength range Δλ₁, wherein the respective emission wavelength (i.e., the first wavelength λ₁) of the laser source is modulated with a first modulation signal of frequency f_{mod1} within the first wavelength range Δλ₁. Tuning is taken to mean detuning of a specific emission wavelength λ within an associated wavelength range Δλ. This may, for example, be continuous or discontinuous tuning (e.g., quasi-continuous tuning with at least one spectral step change range) of a specific emission wavelength λ within an associated wavelength range Δλ. Binary tuning between a wavelength λ and a wavelength λ+δλ detuned relative thereto within a wavelength range Δλ associated with the wavelength λ is also denoted switchover (“digital” modulation). A typical modulation width is around 5 nm to 10 nm. The accessible wavelength ranges Δλ can be correspondingly wide. The maximum frequency f_{mod}, with which the respective emission wavelength of the excitation radiation can be modulated substantially depends on the modulation characteristics of the modulator, the laser source, and the possible readout speed of an associated detector. A preferred modulation frequency f_{mod} is around 0.01 Hz, more preferably 0.1 Hz, more preferably 1 Hz, more preferably 10 Hz, more preferably 100 Hz, and still more preferably 1 kHz. At an assumed emission wavelength of 785 nm, a wavelength range Δλ available for modulation of 10 nm (modulation width) corresponds to a wavenumber range of about 160 cm⁻¹.

The excitation radiation scattered by the sample is spectrally filtered by way of a spectral filter element at a specific filter wavelength v_{Filter} (the symbol v refers to the wavenumber, which is equivalent to wavelength, commonly used in Raman spectroscopy). The spectral filter element may preferably be a passive filter element, in particular a dichroic filter, a Bragg filter (e.g., Bragg grating, VBG, FBG) or a Fabry-Pérot filter. It is likewise preferred to use a diffractive grating, an etalon or a Mach-Zehnder interferometer. Passive means that the filter characteristics of the filter element are not actively modified to record a Raman spectrum, in particular that the filter wavelength v_{Filter} of the spectral filter element is time-invariant.

Spectral filtering is in particular taken to mean filtering in which monochromatic radiation of the filter wavelength v_{Filter} is transmitted by the filter element with a maximum intensity and the spectral ranges adjacent to the filter wavelength v_{Filter} are suppressed or blocked. The spectral filter element may also be an appropriately configured reflective filter element. The filter wavelength v_{Filter} is the center wavelength of the passband (also denoted transmission range) of the filter element. In the case of symmetrical bandpass filters, this is obtained from the spectral position of the center of the bandpass filter. Alternatively, the central wavelength of a filter element can also be determined on the basis of transmission behavior in the passband.

A center wavelength can conveniently be determined on the basis of the center of the spectral range by the filter element having a relative transmission of at least 0.9 compared to its maximum transmission in the passband. This definition is suitable in particular for determining the center wavelength of spectral filter elements with non-symmetrical filter range edges. The width of the passband of the spectral filter element (i.e., its spectral filter width Δv_{Filter}) can also be defined on the basis of its transmission behavior. A passband of the spectral filter element can be defined as the contiguous spectral range within which the relative transmission is preferably at least 0.95 compared to a maximum transmission in the passband. The contiguous spectral ranges in which the relative transmission is at least 0.7; at least 0.8; at least 0.9; or at least 0.99 are furthermore preferred. The blocking range of a filter element can likewise be correspondingly defined on the basis of the transmission characteristics of the spectral filter element within this blocking range. A spectral filter element can be considered to block a wavelength it has for this wavelength a relative transmission of less than 0.3; less than 0.2; less than 0.1; less than 0.5; or less than 0.01 compared to the maximum transmission of the spectral filter element in the passband of its filter wavelength v_{Filter}.

The spectral filter element is preferably spectrally narrow-band. Spectrally narrow-band means that the spectral filter width Δv_{Filter} refers to only a restricted spectral range in the wavelength or wavenumber range of relevance to the apparatus. Particularly preferred passband widths (FWHM) are below 10 nm, below 5 nm, below 1 nm, and below 0.1 nm.

Depending on wavelength range, this corresponds to frequency bandwidths in the lower THz range down to the MHz range.

The first wavelength range Δλ₁ and the spectral filter width Δv_{Filter} relate to disjunct spectral ranges. This means that excitation light that has the first wavelength λ₁ from the first wavelength range Δλ₁ and is directly scattered by the sample is filtered by the spectral filter element. The excitation light can thus only be transmitted or reflected by the spectral filter element if a corresponding frequency shift has previously occurred in the excitation light due to inelastic scattering (e.g., by way of a Stokes or anti-Stokes shift that occurs in the sample). Directly or elastically scattered excitation light (e.g., by Rayleigh scattering or Mie scattering on the sample) is filtered out by the spectral filter element, which means that the SNR cannot be reduced as a result.

The detector is preferably a single-channel detector. This can be both an individual single-channel detector or a multi-channel detector that can be read out individually as a corresponding single-channel detector. This has the advantage that particularly inexpensive, compact, and robust detector devices can be used. It is not necessary to use a high-resolution, low-noise, and sensitive CCD camera. If a multi-channel detector with individual channels is operated as a single-channel detector, a number of channels of the multi-channel detector can also be combined to form an individual single-channel detector.

The apparatus according to the invention comprises a lock-in apparatus via which, using the first modulation signal as a reference signal, a signal-to-noise ratio of a Raman signal of the sample occurring within the spectral filter width Δv_{Filter} of the spectral filter element and modulated with the first modulation signal can be enhanced in the detected measurement signal by corresponding frequency-selective electronic filtration of the Raman signal. The SNR is thus instrumentally enhanced in that the Raman signal to be investigated is modulated by an associated means for tuning the laser source likewise with the first modulation signal of the frequency f_{mod1}, such that the lock-in apparatus can be set to the corresponding reference signal. As a result, additional noise components in the measurement signal caused by ambient and residual scattered light and other factors that interfere with spectroscopy can be effectively suppressed, such that, despite detection via a single-channel detector, the Raman signal can nevertheless be selectively acquired as a corresponding low-noise evaluation signal. Lock-in techniques and lock-in apparatuses are sufficiently well known from the prior art and generally used to filter out a specific frequency-modulated signal from a measurement signal on the basis of a corresponding reference signal.

A lock-in apparatus may in particular be a lock-in amplifier in which the filtered-out signal is additionally amplified. The amplification factor may, however, assume any real value; in particular, the amplification factor of a lock-in amplifier can also be 0, 1 or −1. An amplification factor of 0 means that the signal filtered out with the lock-in amplifier is completely attenuated.

The main idea of the present invention is thus to significantly enhance the SNR over the prior art by using lock-in techniques, so enabling shorter integration times and increased sensitivity over comparable spectroscopy setups. The Raman signal can be acquired and evaluated largely noise-free via an individual single-channel detector. The apparatus according to the invention can consequently be made very compact, simple and inexpensive without any moving mechanical components. Thanks to the simple beam path, excitation power can be varied without additional measures depending on the samples to be investigated.

The spectrally tunable laser source is preferably set up to emit a monochromatic second form of excitation radiation of a second wavelength λ₂ from a second wavelength range Δλ₂ for exciting the sample, wherein the second wavelength λ₂ of the laser source is modulated by the means for tuning the laser source with a second modulation signal of frequency f_{mod2} (within the associated second wavelength range Δλ₁), and wherein the lock-in apparatus is set up to filter out from the measurement signal, using the second modulation signal as a reference signal, a Raman signal of the sample occurring within the spectral filter width Δ_{vFilter} of the spectral filter element and modulated with the second modulation signal. Using the second modulation signal, the lock-in apparatus can thus enhance a signal-to-noise ratio in the measurement signal of a Raman signal of the sample occurring within the spectral filter width Δv_{Filter} Of the spectral filter element and modulated with the first modulation signal.

The spectrally tunable laser source is preferably set up to emit at least one further monochromatic form of excitation radiation of a further wavelength λ₃ from a further wavelength range Δλ₃ for exciting the sample, wherein the at least one further wavelength λ₃ of the laser source is modulated by the means for tuning the laser source with at least one further modulation signal of frequency f_{mod3} (within the at least one further associated wavelength range Δλ₃), and wherein the lock-in apparatus is set up to filter out from the measurement signal, using the at least one further modulation signal as a reference signal, a Raman signal of the sample occurring within the spectral filter width Δv_{Filter} of the spectral filter element and modulated with the at least one further modulation signal. Using the at least one further modulation signal, the lock-in apparatus can thus enhance a signal-to-noise ratio in the measurement signal of a Raman signal of the sample occurring within the spectral filter width Δv_{Filter} of the spectral filter element and modulated with the at least one further modulation signal.

The different forms of excitation radiation are preferably emitted simultaneously, but the individual forms of excitation radiation can also be emitted with a time delay. The forms of excitation radiation can, for example, be provided by using a plurality of laser diodes emitting at different emission wavelengths within the laser source. The different forms of excitation radiation at different excitation wavelengths can furthermore be generated by a single laser diode with a variable emission wavelength or by a correspondingly spectrally tunable diode laser. In addition to the discrete provision of individual, spaced-apart emission wavelengths (for example at a spacing of 10 nm or 20 nm), it is also possible to make an appropriate selection of individual emission wavelengths from a wide available spectral range of the laser source.

It is preferred to use laser diodes, in which different modes can be excited, such that for example larger, at least discretely achievable wavelength ranges at a spacing of a number of tens of nm can be achieved. Directly frequency-modulated laser diodes, in which a change in wavelength can be set by way of intrinsic diode parameters, for example via a temperature or a current, are also preferred. “Dual wavelength” or “multiwavelength” lasers, for example a Y-branched dual wavelength DBR diode laser (e.g., Maiwald et al., “Dual-Wavelength Y-Branch Distributed Bragg Reflector Diode Laser at 785 Nanometers for Shifted Excitation Raman Difference Spectroscopy”, Appl. Spectrosc. 69, 1144-1151 (2015)) may preferably be used. It is furthermore preferred for the laser source to be a correspondingly narrow-band diode laser that is spectrally tunable over a wide range. This may be, for example, an ECDL system or a spectrally tunable diode-pumped solid-state laser. Correspondingly tunable dye or fiber lasers are also particularly suitable.

The wavelength ranges associated with the at least two forms of excitation radiation, i.e., all the wavelength ranges associated with the respective forms of excitation radiation are disjoint from one another. This means that, in terms of modulation too, the respective forms of excitation radiation have no spectral overlaps and the adjustable forms of excitation radiation can thus be uniquely associated with individual wavelength ranges. In conjunction with a spectral filter element having a specified filter wavelength v_{Filter}, this means that the wavenumber ranges resolved spectroscopically by the modulation are also disjoint from one another.

Preferably, at least two of the forms of excitation radiation are selected for a predetermined sample to be investigated in such a way that different Raman signals occur within the spectral filter width Δv_{Filter} Of the spectral filter element. This embodiment can in particular be applied to samples that have a different composition (e.g., different molecules, chemical groups etc.). In these cases, the different forms of excitation radiation can be set up to measure different Raman lines of the individual components of the composition. It is then for example possible to determine a mixture ratio of the composition on the basis of the ratio of the intensities of the measured Raman signals. However, the different Raman signals occurring within the spectral filter width Δv_{Filter} Of the spectral filter element may also be formed by different Raman lines of an individual sample component. The reliability of a sample determination can be increased by evaluating a number of Raman lines from an individual sample component.

Preferably, at least two of the forms of excitation radiation are modulated via the respective modulation signals with a uniform frequency and phase angle. Such an embodiment has the advantage that, for example, two different Raman lines (i.e., belonging to different wavenumber spacings) of two Raman signals filtered from the two forms of excitation radiation via the spectral filter element are acquired by the lock-in apparatus at the common modulation frequency as a sum signal. The signal level measured by the lock-in apparatus is then a superposition of two different Raman signals from an individual sample component. Compared to the acquisition of just one specific Raman signal, the SNR can thus be significantly still further increased by measuring a plurality of Raman signals in parallel.

In particular, a correspondingly high maximum signal level (e.g., above a specific threshold value) can be used as the basis to infer the simultaneous occurrence of different Raman lines from a specific sample component (or a specific sample material). Such summation Raman spectroscopy can achieve high sensitivity and reliability of the spectroscopy setup, in particular for the specific determination of individual samples, at the shortest integration times.

The occurring Raman signals are preferably based on both a Stokes shift and an anti-Stokes shift. The phrase “occurring Raman signal” refers to the actual presence in the measurement signal of a Raman signal from the sample that occurs within the spectral filter width Δv_{Filter} Of the spectral filter element and is modulated with the first modulation signal. The phrase thus assumes a signed spectral spacing (wavenumber spacing) between the wavelength of the excitation radiation modulated in the associated wavelength range and the filter wavelength v_{Filter} of the spectral filter element used.

The Stokes shift involves a transfer of energy from photons of the excitation radiation to the scattering sample. After the scattering process, the molecules or the like of the sample are at a higher energy level than before and the energy and frequency of the scattered photons are lower than those of the exciting photons. The anti-Stokes shift involves a transfer of energy from the sample to the photons of the excitation radiation. After the excitation process, the molecules or the like of the sample are at a lower energy level than before and the scattered photons have a higher energy and a higher frequency than the exciting photons.

In the preferred embodiment, both Stoke-and anti-Stokes shifts are thus acquired as Raman signals. The ratio of the intensities of the respective Stokes and anti-Stokes shifts of the Raman signals can in particular be used to perform a temperature measurement on the sample. In the case of a spatially extensive sample that comprises different components, it is thus also possible to perform a highly location-and material-specific temperature measurement of an individual component of the composition of the sample. State-specific temperature measurement is likewise possible, for example of a single rotational and vibrational state of a molecule in thermal non-equilibrium.

An apparatus according to the invention preferably comprises at least one display device for displaying the measurement signal filtered with the lock-in apparatus. A display device may preferably be a simple analog or digital pointer element or a binary display element (e.g., luminous signal when a certain threshold value is exceeded). It may furthermore be a display device, preferably an analog or digital y-t-plotter for portraying the Raman signal as a time profile in a corresponding diagram. Different Raman signals are preferably each shown on an associated display device.

The stated embodiments can advantageously be combined with one another in their entirety or in part.

A further aspect of the invention relates to a method for Raman spectroscopy using an apparatus according to the invention, wherein the spectral spacing between the wavelength (λ₁, λ₂, λ₃) of at least one form of excitation radiation (L₁, L₂, L₃) and a filter wavelength v_{Filter} of the spectral filter element corresponds to the wavenumber spacing Δ\tilde{v} of a Raman signal of a predetermined sample. In Raman spectroscopy, the occurrence of at least one specific Raman line is spectroscopically investigated on excitation of a sample with an excitation radiation. Therefore, in order to be able to perform Raman spectroscopy on a predetermined sample with an apparatus according to the invention, at least one spectral spacing between the wavelength λ of the monochromatic excitation radiation modulated in the associated wavelength range Δλ and a filter wavelength v_{Filter} of the spectral filter element must be specified to the wavenumber spacing Δ\tilde{v} of a Raman signal of a predetermined sample. If a corresponding Raman signal does not occur during spectroscopy of a specific sample, it can therefore at least be concluded that the sample predetermined for a corresponding test is absent.

A further aspect of the invention relates to the use of a method according to the invention for measuring a temperature of a sample or a mixture ratio of a sample. The temperature of a sample can in particular be measured via the ratio of the intensities of the respective Stokes and anti-Stokes shifts of the Raman signals. The mixture ratio of a sample that has a differing composition (e.g., different molecules, chemical groups etc.), can be measured by the ratio of the intensities of individual Raman lines of the different components. The method according to the invention can accordingly also be used for recording the time profile of a mixture ratio (e.g., for in situ monitoring of chemical reactions within reactors). The mixture ratio of a sample can be used, for example, for determining the degree of saturation of a solution or for determining a degree of polymerization in a polymerizable monomer solution. In addition, further preferred configurations of the method according to the invention are directly revealed by the features stated in the description in relation to the apparatus according to the invention.

Further preferred configurations of the invention are revealed by the features mentioned in the respective subclaims.

The different embodiments of the invention set out in this application are advantageously able to be combined with one another unless otherwise specified.

### BRIEF DESCRIPTION OF THE DRAWINGS

The invention and the technical context are explained in greater detail below with reference to the appended figures. It should be noted that it is not intended for the invention to be limited by the recited exemplary embodiments. In particular, unless explicitly stated otherwise, it is also possible to extract sub-aspects of the subject matter explained in the figures and combine them with other components and insights from the present description. In the drawings:

FIGS. 1A-1C show a schematic representation of a first embodiment of an apparatus according to the invention for Raman spectroscopy with associated spectra;

FIGS. 2A-2C show a schematic representation of a second embodiment of an apparatus according to the invention for Raman spectroscopy with associated spectra;

FIG. 3 shows a schematic representation of a third embodiment of an apparatus according to the invention for Raman spectroscopy with associated spectra; and

FIGS. 4A and 4B show an exemplary representation of the spectra of the third embodiment of an apparatus according to the invention according to FIG. 3.

### DETAILED DESCRIPTION OF THE DRAWINGS

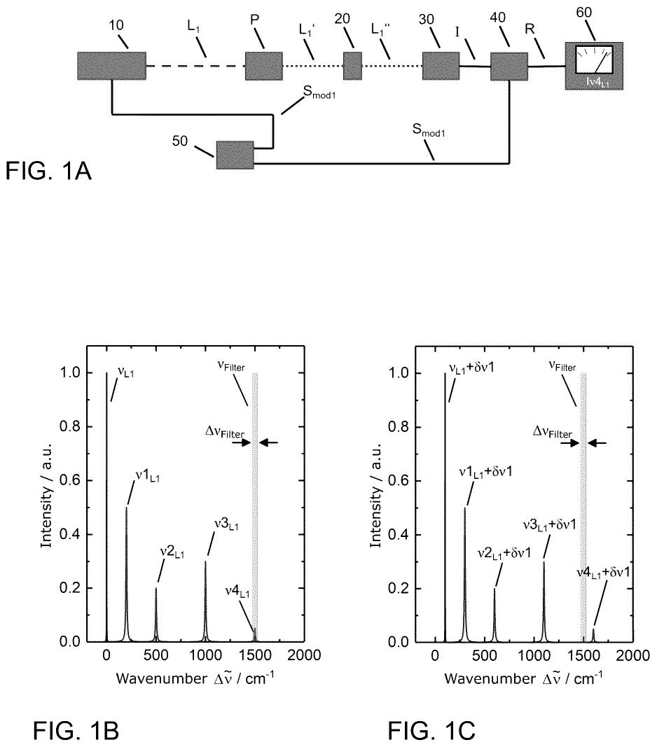

FIGS. 1A-1C illustrate a schematic representation of a first embodiment of an apparatus according to the invention for Raman spectroscopy with associated spectra. The apparatus shown in a) comprises a spectrally tunable laser source 10 set up to emit a first monochromatic form of excitation radiation L₁ of a first wavelength λ₁ from a first wavelength range Δλ₁ for exciting a sample P; a spectral filter element 20 at a filter wavelength v_{Filter} and with a spectral filter width Δ_{vFilter}, wherein the first wavelength range Δλ₁ and the spectral filter width Δv_{Filter} relate to disjoint spectral ranges; a detector 30 for measuring the intensity of the first excitation radiation L₁′ scattered by the sample P (i.e., the first form of excitation radiation L₁′ scattered by the sample) and filtered by the spectral filter element 20 (i.e., the excitation radiation L₁″ scattered by the sample and filtered by the spectral filter element) as a measurement signal I; means for tuning the laser source 50, wherein, for tuning the first wavelength λ₁ of the laser source 10, modulation is performed with a first modulation signal S_{mod1} of frequency f_{mod1} (within the associated first wavelength range Δλ₁); and a lock-in apparatus 40 set up to filter out from the measurement signal I, using the first modulation signal S_{mod1} as a reference signal, a Raman signal R of the sample P occurring within the spectral filter width Δv_{Filter} of the spectral filter element 20 and modulated with the first modulation signal S_{mod1}. The apparatus shown furthermore comprises a display device 60 for displaying the measurement signal I filtered with the lock-in apparatus 40 at a modulation frequency (f_{mod1}). Filtration can enhance the signal-to-noise ratio in the measurement signal I of the Raman signal R of the sample P modulated with the first modulation signal S_{mod1}.

The spectra shown in b) and c) show the spectral relationships during modulation. The spectra show the intensities both of the excitation radiation (v_{L1}) and of the individual Raman lines v1_{L1}−v4_{L1} (the symbol v relates to the wavenumber conventionally used in Raman spectroscopy, statement of which corresponds to stating the wavelength and which was selected for ease of representation) of a specific sample plotted over the respective wavenumber spacing Δ\tilde{v} against the excitation radiation (v_{L1}). The filter range of a spectral filter element 20 at a filter wavelength v_{Filter} and with a spectral filter width Δv_{Filter} is also indicated. The wavenumber spacing between an output wavelength λ of the excitation radiation (v_{L1}) and the filter wavelength v_{Filter} of the spectral filter element 20 is in this example 1500 cm⁻¹. FIG. 1B shows the ratios for an excitation radiation (v_{L1}) of a specific output wavelength λ without a modulation shift. FIG. 1C shows the modified ratios in the case of excitation radiation (v_{L1}+δv₁) shifted by a corresponding modulation of the excitation radiation v_{L1} at the output wavelength λ. The entire Raman spectrum is likewise spectrally shifted by the same amount δv₁, such that in the example shown the fourth Raman line v4_{L1}+δv₁ is shifted outside the spectral filter width Δv_{Filter} of the spectral filter element 20.

Raman line v4_{L1} can thus be detected with the assistance of the spectral filter element 20 by simple modulation of the excitation radiation between v_{L1} and v4_{L1}+δv₁.

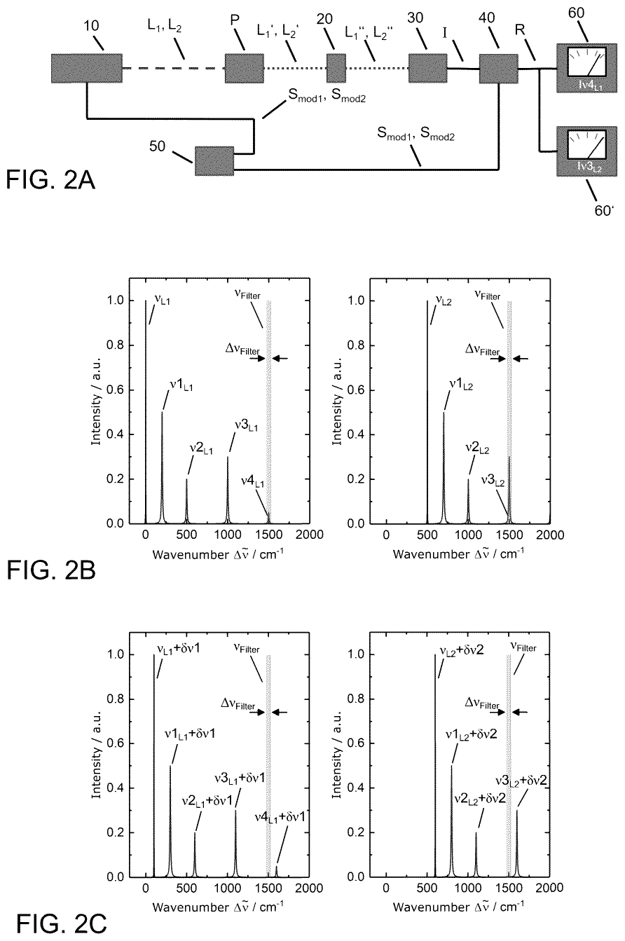

FIGS. 2A-2C illustrate a schematic representation of a first embodiment of an apparatus according to the invention for Raman spectroscopy with associated spectra. The apparatus shown in a) substantially corresponds to the embodiment shown in FIG. 1A. The reference signs and their respective assignment to individual features of the apparatus therefore apply accordingly. In contrast to the embodiment shown in FIG. 1A, the spectrally tunable laser source 10 is however set up to emit a second monochromatic form of excitation radiation L₂ of a second wavelength λ₂ from a second wavelength range Δλ₂ for exciting the sample P, wherein the second wavelength λ₂ of the laser source 10 is modulated by the means for tuning the laser source 50 for tuning with a second modulation signal S_{mod2} of frequency f_{mod2} (within the associated second wavelength range Δλ₂), and the lock-in apparatus 40 is set up to filter out from the measurement signal I, using the second modulation signal S_{mod2} as a reference signal, a Raman signal R of the sample P occurring within the spectral filter width Δ_{vFilter} of the spectral filter element 20 and modulated with the second modulation signal S_{mod2}. The apparatus shown furthermore comprises two display devices 60, 60′ for displaying the measurement signal I filtered with the lock-in apparatus 40 at two modulation frequencies (f_{mod1}, f_{mod2}).

The spectra shown in FIGS. 2B and 2C show the spectral relationships during modulation of the individual forms of excitation radiation corresponding to the ratios shown in FIGS. 1B and 1C. The wavenumber spacing between the first form of excitation radiation v_{L1} and the second form of excitation radiation v_{L2} in this example is 500 cm⁻¹. Thus, as shown in FIG. 2B, the two Raman lines v4_{L1} and v3_{L2} are detected by corresponding modulation of the respective forms of excitation radiation (v_{L1}, v_{L2}) at different modulation frequencies by way of spectral tuning (e.g., by detuning, tuning or switchover) with the assistance of the spectral filter element 20.

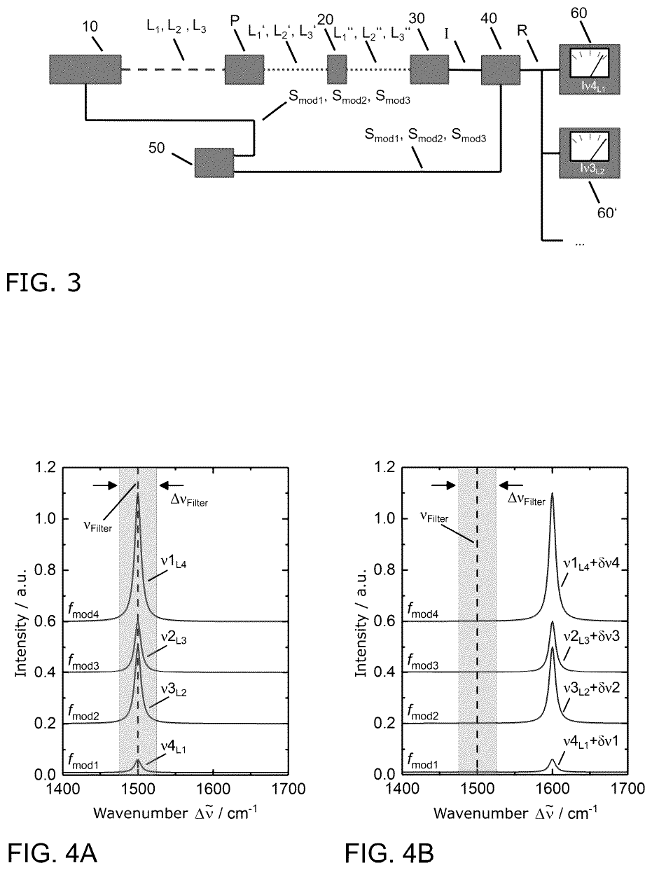

FIG. 3 shows a schematic representation of a third embodiment of an apparatus according to the invention for Raman spectroscopy with associated spectra. The apparatus shown in a) substantially corresponds to the embodiment shown in FIG. 2A. The reference signs and their respective assignment to individual features of the apparatus therefore apply accordingly. In contrast to the embodiment shown in FIG. 2A, the spectrally tunable laser source 10 is however set up to emit at least one further monochromatic form of excitation radiation L₃ of a further wavelength λ₃ from a further wavelength range Δλ₃ for exciting the sample P, wherein the at least one further wavelength λ₃ of the laser source 10 is modulated by the means for tuning the laser source 50 for tuning with at least one further modulation signal S_{mod3} of frequency f_{mod3} (within the at least one further associated wavelength range Δλ₃), and the lock-in apparatus 40 is set up to filter out from the measurement signal I, using the at least one further modulation signal S_{mod3} as a reference signal, a Raman signal R of the sample P occurring within the spectral filter width Δv_{Filter} of the spectral filter element 20 and modulated with the at least one further modulation signal S_{mod3}. The apparatus shown furthermore comprises at least two display devices 60, 60′ for displaying the measurement signal I filtered with the lock-in apparatus 40 at three modulation frequencies (f_{mod1}, f_{mod2}, f_{mod3}).

FIGS. 4A and 4B illustrate an exemplary representation of the spectra of the third embodiment of an apparatus according to the invention according to FIG. In this embodiment, four monochromatic forms of excitation radiation (v_{L1}, v_{L2}, v_{L3}, v_{L4}) for a predetermined sample P to be spectroscopically investigated are selected in such a way that different Raman lines (v1_{L4}, v2_{L3}, v3_{L2}, v4_{L1}) occur within the spectral filter width Δ_{vFilter} of the spectral filter element 20. Correspondingly to the representations in FIGS. 1B and 1C, FIG. 4A shows the spectrally superimposed Raman lines (v1_{L4}, v2_{L3}, v3_{L2}, v4_{L1}) for the unmodulated forms of excitation radiation at specific output wavelengths λ located within the spectral filter width Δ_{vFilter} of the spectral filter element 20, while b) shows the modified ratios in the case of corresponding modulation of the forms of excitation radiation (v_{L1}, v_{L2}, v_{L3}, v_{L4}) at output wavelength λ, shifted Raman lines v1_{L4}+δv₄, v2_{L3}+δv₃, v3_{L2}+δv₂, v4_{L1}+δv₁ and shifted forms of excitation radiation (v_{L1}+δv₁, v_{L2}+δv₂, v_{L3}+δv₃, v_{L4}+δv₃). The monochromatic forms of excitation radiation (v_{L1}, v_{L2}, v_{L3}, v_{L4}) can to this end be modulated mutually independently via corresponding modulation signals S_{mod1}, S_{mod2}, S_{mod3}, S_{mod4} and the associated Raman signals can in each case be displayed on a display device 60, 60′.

### LIST OF REFERENCE NUMERALS

10 Spectrally tunable laser source
20 Spectral filter element
30 Detector
40 Lock-in apparatus
50 Means for tuning the laser source
60,60′ Display devices
L₁ First form of excitation radiation
L₁′ Excitation radiation scattered by the sample
L₁″ Excitation radiation scattered by the sample and filtered by the spectral filter element
L₂ Second form of excitation radiation
L₂′ Second form of excitation radiation scattered by the sample
L₂″ Second form of excitation radiation scattered by the sample and filtered by the spectral filter element
L₃ Further form of excitation radiation
L₃′ Further form of excitation radiation scattered by the sample
L₃″ Further form of excitation radiation scattered by the sample and filtered by the spectral filter element
P Sample
I Measurement signal
R Raman signal
S_{mod1} First modulation signal
S_{mod2} Second modulation signal
S_{mod3} Third modulation signal

1. An apparatus for Raman spectroscopy comprising:
a spectrally tunable laser source set up to emit a monochromatic first form of excitation radiation of a first wavelength λ₁ from a first wavelength range Δλ₁ for exciting a sample;
a spectral filter element at a filter wavelength v_{Filter} and with a spectral filter width Δv_{Filter}, wherein the first wavelength range Δλ₁ and the spectral filter width Δv_{Filter} relate to disjunct spectral ranges;
a detector for measuring the intensity of the excitation radiation scattered by the sample and filtered by the spectral filter element measurement signal;
a means for tuning the laser source, wherein the first wavelength λ₁ of the laser source is modulated with a first modulation signal of frequency f_{mod1}; and
a lock-in apparatus set up to filter out from the measurement signal, using the first modulation signal as a reference signal, a Raman signal of the sample occurring within the spectral filter width Δ_{vFilter} of the spectral filter element and modulated with the first modulation signal.

2. The apparatus of claim 1, wherein the spectrally tunable laser source is set up to emit a monochromatic second form of excitation radiation of a second wavelength λ₂ from a second wavelength range Δλ₂ for exciting the sample (P), the second wavelength λ₂ of the laser source is modulated by the means for tuning the laser source with a second modulation signal of frequency f_{mod2}, and the lock-in apparatus is set up to filter out from the measurement signal, using the second modulation signal as a reference signal, a Raman signal of the sample occurring within the spectral filter width Δ_{vFilter} of the spectral filter element and modulated with the second modulation signal.

3. The apparatus of claim 2, wherein the spectrally tunable laser source is set up to emit at least one further monochromatic form of excitation radiation of a further wavelength λ₃ from a further wavelength range Δλ₃ for exciting the sample, the at least one further wavelength λ₃ of the laser source is modulated by the means for tuning the laser source with at least one further modulation signal of frequency f_{mod3}, and the lock-in apparatus is set up to filter out from the measurement signal, using the at least one further modulation signal as a reference signal, a Raman signal of the sample occurring within the spectral filter width Δ_{vFilter} of the spectral filter element and modulated with the at least one further modulation signal.

4. The apparatus of claim 2, wherein the wavelength ranges associated with at least two forms of excitation radiation are disjoint from one another.

5. The apparatus of claim 2, wherein, for a predetermined sample to be spectroscopically investigated, at least two of the forms of excitation radiation are selected such that different Raman signals occur within the spectral filter width Δ_{vFilter} of the spectral filter element.

6. The apparatus of claim 2, wherein at least two of the forms of excitation radiation are modulated via the respective modulation signals with a uniform frequency and phase angle.

7. The apparatus of claim 2, wherein the occurring Raman signals are based on both a Stokes shift and an anti-Stokes shift.

8. The apparatus of claim 1, furthermore comprising at least one display device for displaying the measurement signal filtered by the lock-in apparatus.

9. A method comprising: utilizing the apparatus of claim 1 for Raman spectroscopy, wherein the spectral spacing between the wavelength of at least one form of excitation radiation and a filter wavelength v_{Filter} of the spectral filter element corresponds to the Δ\tilde{v} wavenumber spacing of a Raman signal a predetermined sample.

10. The method of claim 9, further comprising: measuring a temperature of a sample or a mixture ratio of a sample.
